(19) United States
(12) Patent Application Publication
(10) Pub. No.: US 2003/0043188 A1
(43) Pub. Date: Mar. 6, 2003

(54) Code read communication software

(76) Inventor: John Bernard Daron, Houston, TX (US)

Correspondence Address: John Bernard Daron, 9006 ARBORWOOD DRIVE, HOUSTON, TX, 77040, US

(21) Appl. No.: 10/223,509

(22) Filed: Aug. 19, 2002

Related U.S. Application Data
(60) Provisional application No. 60/316,451, filed on Aug. 30, 2001.

(51) Int. Cl. G09G 5/00

(52) U.S. Cl. 345/752

(57) ABSTRACT

A software based process of data and or instruction transfer between intelligent devices and a new data formatting architecture is disclosed which is based on e-mail characteristic formatting to create a code to communicate computer instructions and data between intelligent devices. Intelligent devices are those devices, which are capable of sending and receiving e-mail messages and attachments. This formatting of e-mail characteristics and parameters is a patentable process and it is one of the claims of this application.

This software based process will provide screening features, notification features and productivity features specifically targeted to helping individuals or companies in handling incoming and outgoing e-mail and to help individuals or companies to automate and facilitate other common work items. This process includes the creation and storage of e-mail messages, including e-mail messages that contain data and instructions, based on this process, for subsequent transmittal to other intelligent devices.

### BACKGROUND OF THE INVENTION

A software based process and software architecture enhances common email programs and changes them into productivity applications by extending the common abilities of an industry standard email software program to other areas such as automated bill payment, password protected email, controlling of electrical appliances/auxiliary devices, monitoring of input devices, the automated sending of pre-written email, and the screening and sorting of incoming email for further processing.

### ABSTRACT OF THE DISCLOSURE

A software based process of data and instruction transfer between intelligent devices and a new data formatting architecture is disclosed which is based on e-mail characteristic formatting to create a code to communicate computer instructions and data between intelligent devices. Intelligent devices are those devices, which are capable of sending and receiving e-mail messages and attachments. This formatting of e-mail characteristics and parameters is a patent-able process and it is one of the claims of this application.

This software based process will provide screening features, notification features and productivity features specifically targeted to helping individuals or companies in handling incoming and outgoing e-mail and to help individuals or companies to automate and facilitate other common work items. This process includes the creation and storage of email messages, including email messages that contain data and instructions, based on this process, for subsequent transmittal to other intelligent devices.

### BRIEF SUMMARY OF THE INVENTION

This software based process includes and is structured on a proprietary programming language based on e-mail characteristic formatting to create a code to communicate computer instructions between intelligent devices. Intelligent devices are those devices, which are capable of sending and receiving e-mail messages and attachments. This formatting of e-mail characteristics and parameters and or the subseluent screening based on this formatting is a patentable process and it is one of the claims of this application.

This software will allow a user or a computer device to be notified in a number of ways as a result of a specific incoming e-mail characteristic or format. This software will also allow the user to signal outside parties or computer devices by e-mail, including that which is formatted according to this process and by other means as a result of either manual user inputs or automated inputs.

The software based process, which is the subject of this application, may be viewed as a utility type software program, which can be utilized in the business enterprise market or alternately in the home software market. This software program, Code Read Software (Code Read), includes some new features and some common features. This program and its processes, in contrast to what is commonly found in the current market, is architected to facilitate its productivity features with all common standards based email programs and provide productivity enhancements to common email programs. This software based process derives its utility from the use of email and the novel and innovative use of email parameters and header characteristics as a programming language and the transmitting of information (data) and instructions via the formatting of these email items between devices capable of sending and receiving email.

This software architecture may also be viewed as an email operating system or middleware, which will facilitate the integration of email programs and other productivity applications.

This software program is currently comprised of the following five (5) features, which are enabled due to the underlying formatting and subsequent scanning for formatting of email parameters and header characteristics. The process of transmitting instructions and data by formatting email parameters, which is the basis of this disclosure, will enable countless features in the future.

(1) E-Mail Based Bill Payment.

Prior payment systems were based on either mailing checks to the vendors or were based on the individual having to visit band sites on the internet or alternately visiting vendor sites and posting payment in one fashion or another. These prior art systems were either time consuming or expensive or both.

(2) The Control of External Devices

The control of External Devices, which are triggered by screened e-mail, is another feature of Code Read Software and its processes. An example would be the remote control of computer-connected appliances. The prior art of controlling home appliances involved a person being on site or the use of a timer.

(3) Mystery E-Mail.

Mystery email uses a password embedded in the email parameters and characteristics and therefore only requires the receiving party to decode the parameters to unlock the email message. In prior art, existing applications had to rely on encryption or OS level controls. This is cumbersome, expensive, complicated and beyond the needs of the general public, who basically have a privacy issue and not a security issue.

(4) E-Mail Controlled Alarms and Notifications

This is the control of computer peripherals by the information delivered in e-mail characteristics and parameters. This is a utility type software process and will enable this function with any email program. In prior art, only some premium priced email programs had this capability.

(5) Hot button e-mail messages.

This is the combination of a pre-written email coupled with a device to trigger the sending of the email message. In prior art, all emails were either written manually at the time of sending or were part of an integrated email application. Canned messages, such as “out of Office” replies in MS Outlook, are integrated parts of the email software. Code Read Software is a utility type program and will work with all email programs. Alternately, sensors may activate canned email messages. In prior art sensors may trip a burglar alarm and then an individual would have to call the police. This Code Read Software process and method can send multiple parties messages, neighbors, relatives, police, ambulance and also the owner by way of wireless email, providing the owner were away from his property.

### BRIEF DESCRIPTION OF THE SEVERAL VIEWS OF THE DRAWING

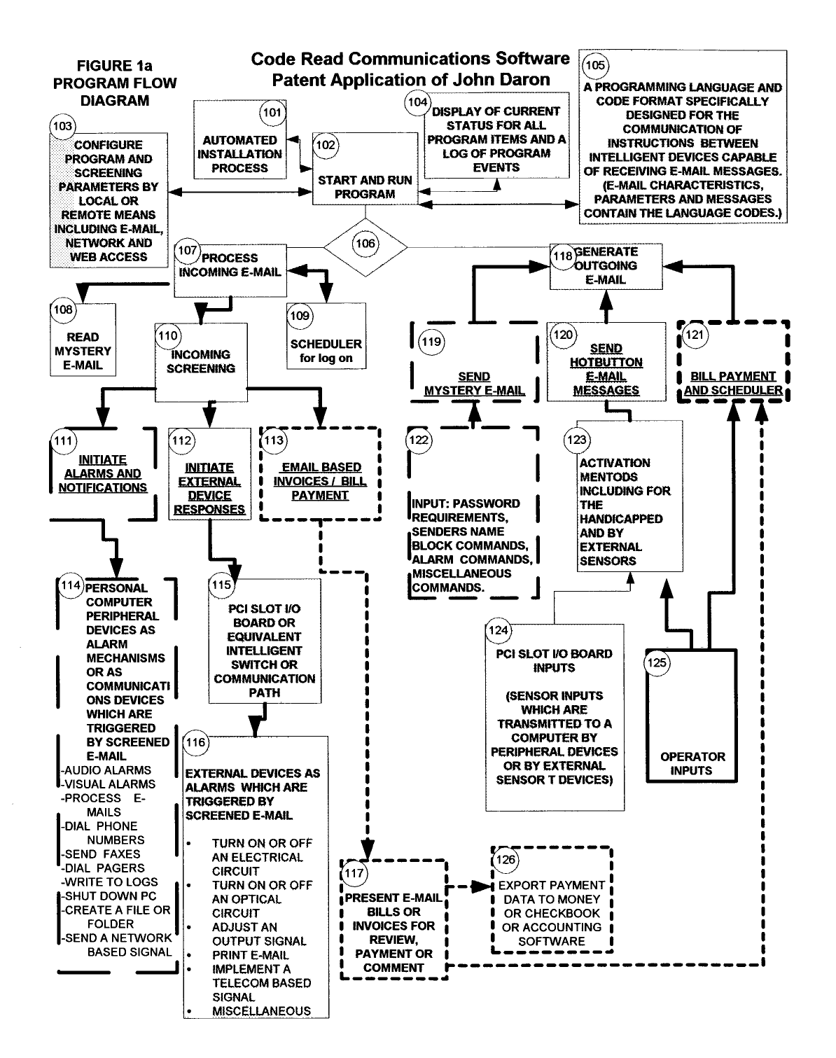

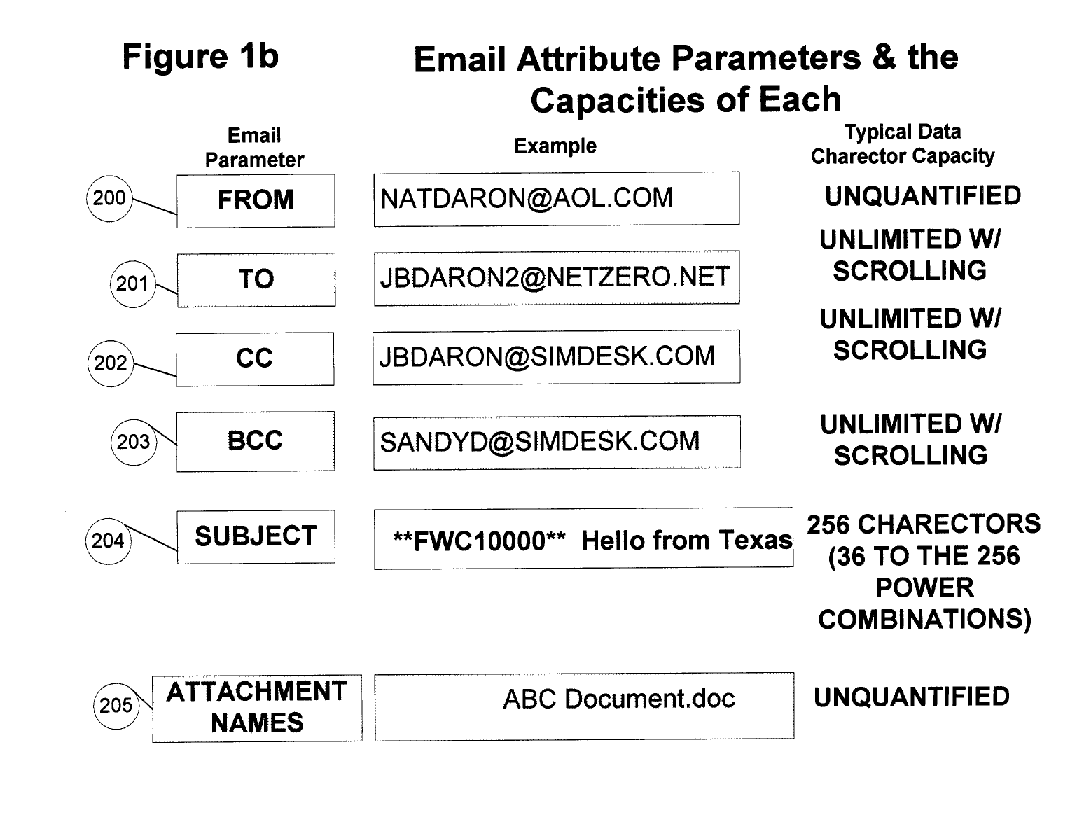

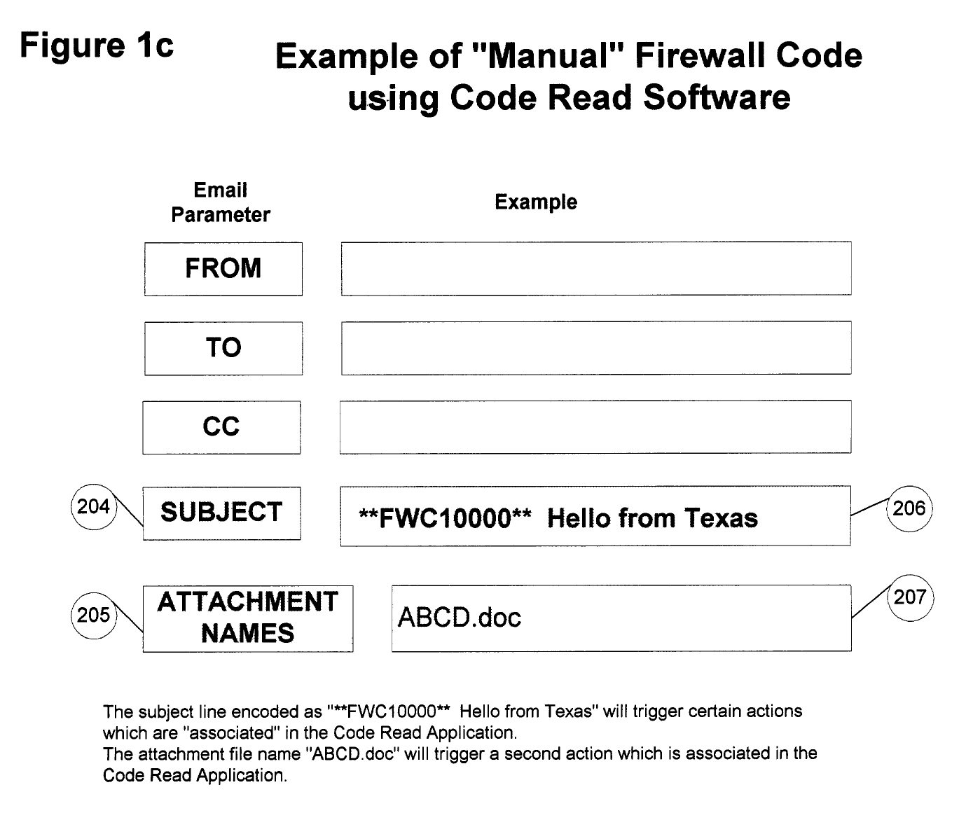

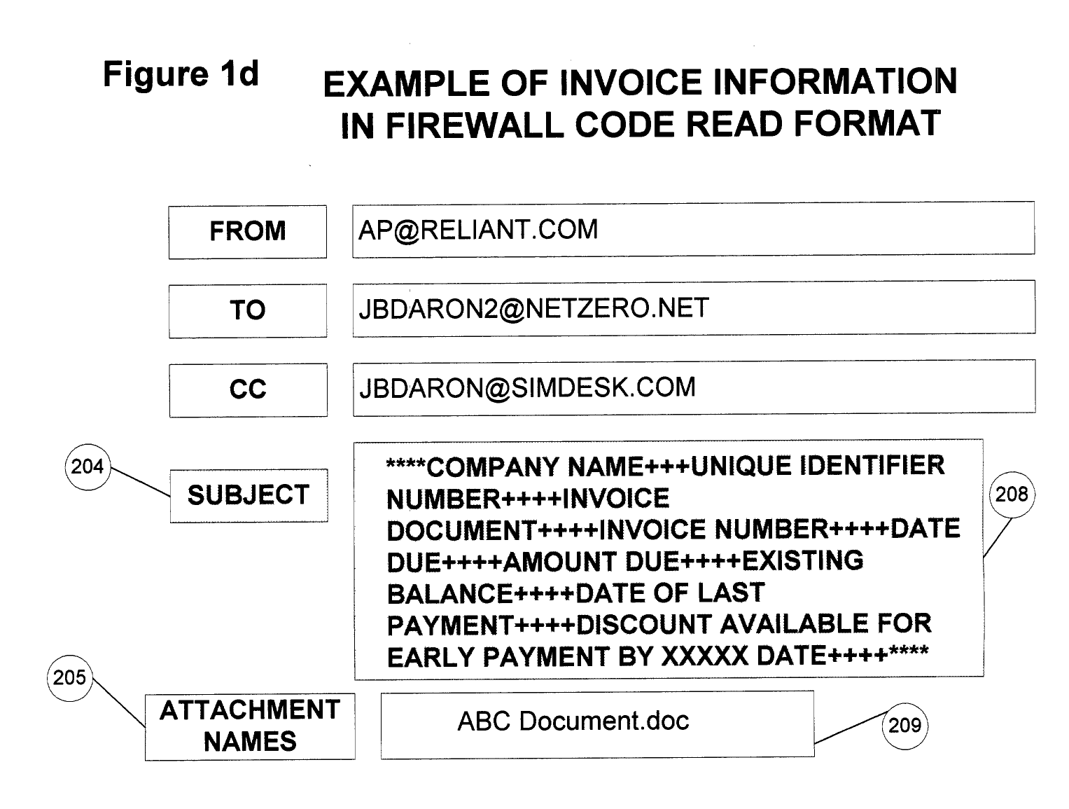

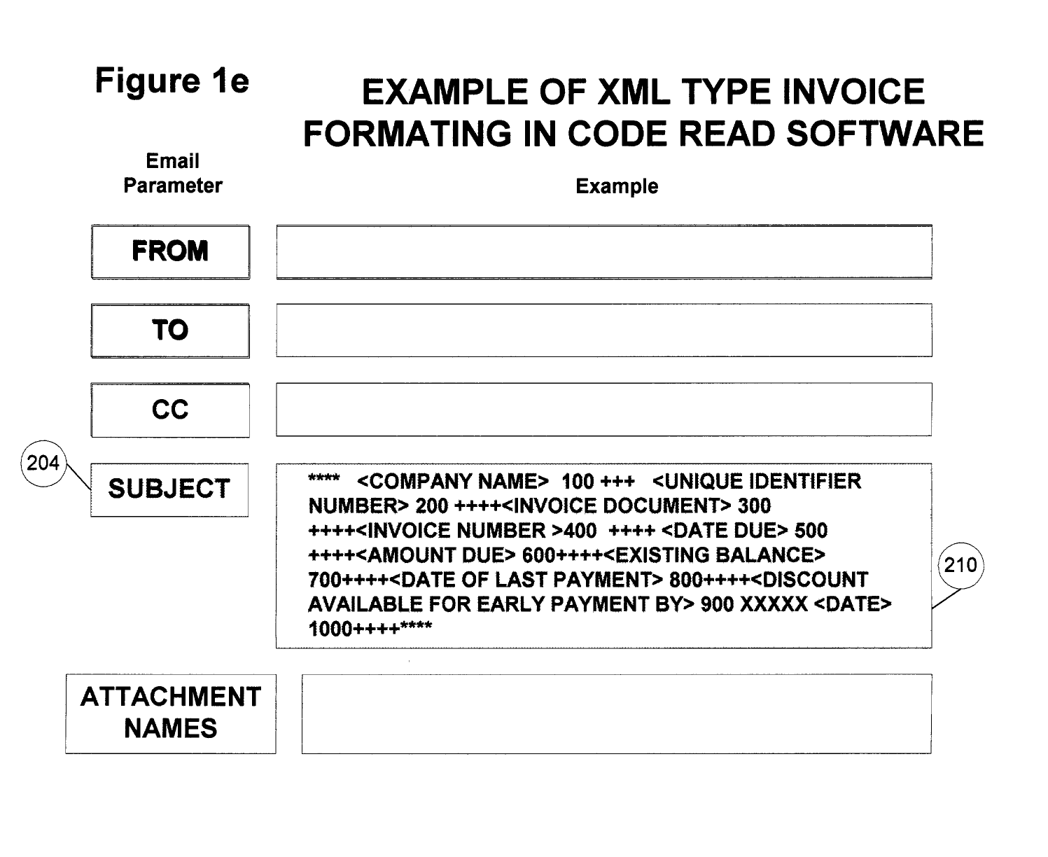

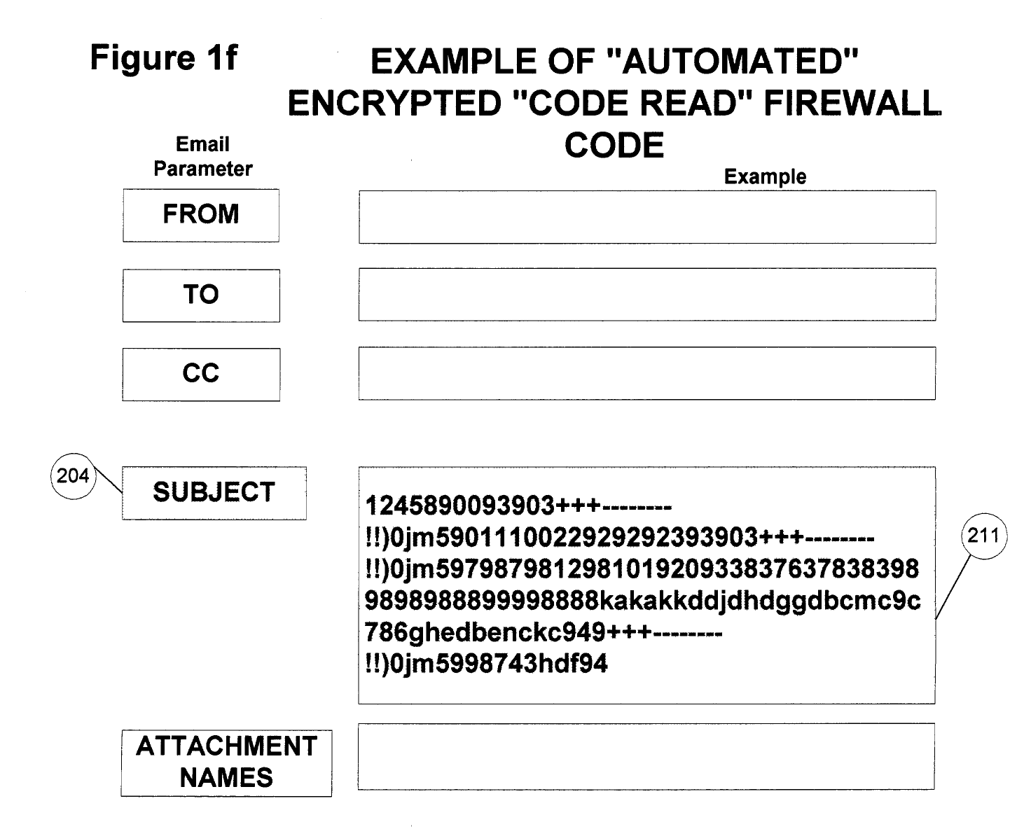

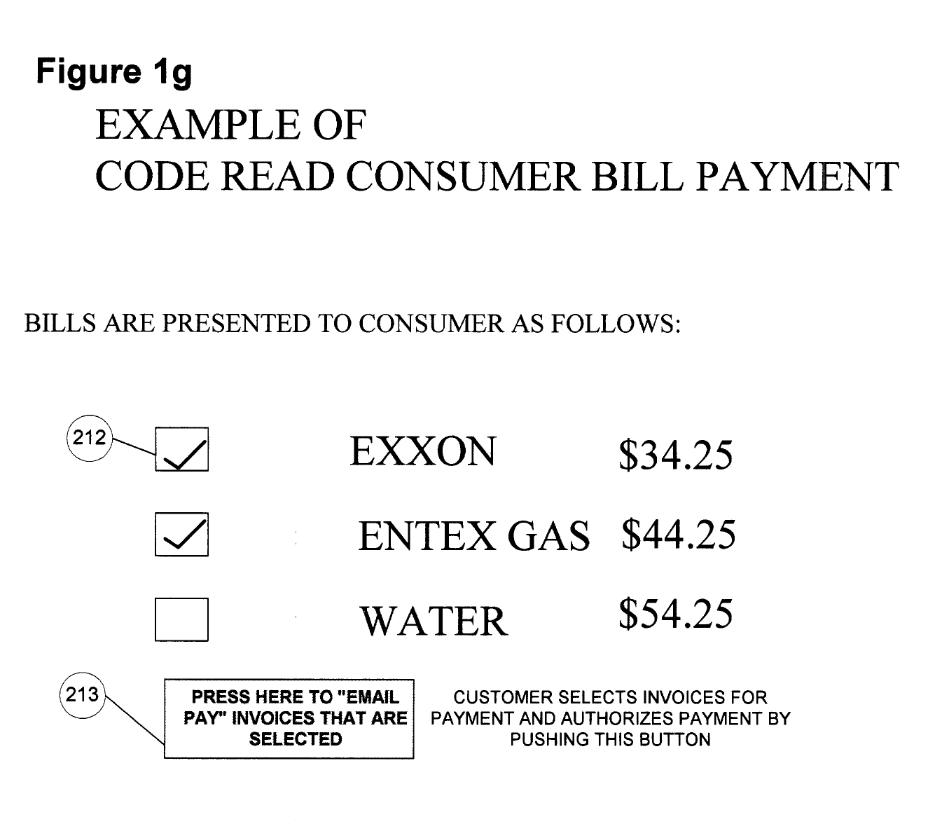

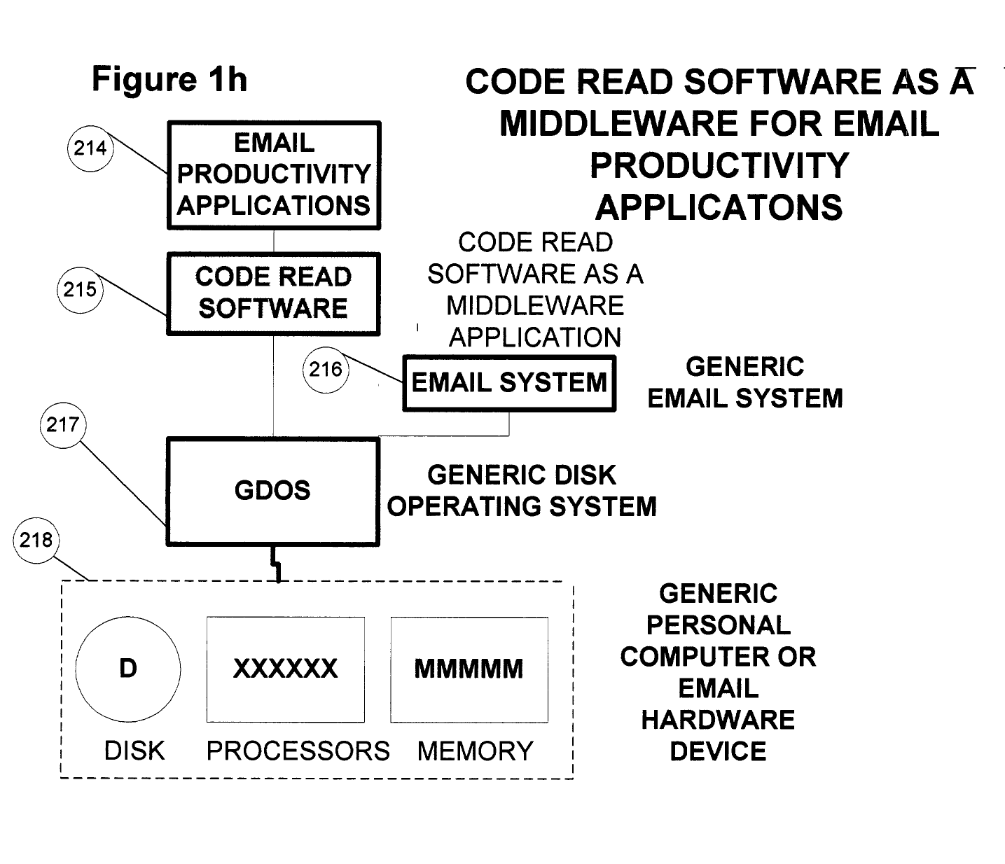

The figures listed in this application are FIGS. 1a-1h and 2-7 (14 figures total)

### INTRODUCTION TO DRAWINGS

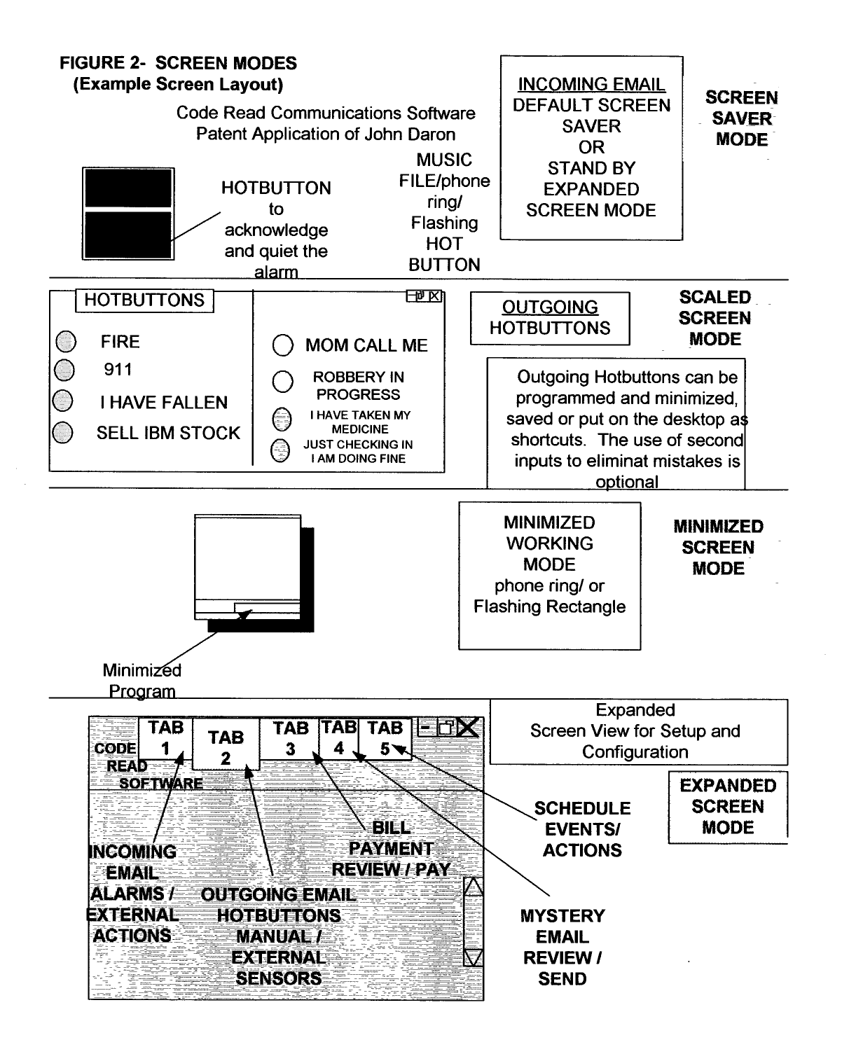

The Flow diagram included with this application (FIG. 1a) shows the functions of this software based process as well as the general flow of the user operations. FIGS. 1b illustrates Email Attributes and Parameters and further reveals the data capacity of each. FIGS. 1c, 1d, 1e, 1f and 1g illustrate examples of the use of email parameters to communicate data. FIG. 1h illustrates Code Read as a middleware component in the deployment of email productivity applications. FIG. 1a has items 101-126 identified as components of the flow diagram. FIG. 2 shows on overview of some of the program screen modes and features. Drawings 3-7 illustrate potential screen layouts with typical GUI screen arrangements. These screen shots are provided to convey the user interface concepts and are not a guarantee of the final screen graphics or layout.

The complete list of figures for this application is as follows:

FIG. 1a Program Flow Diagram

The flow diagram indicates the overall flow and structure of the application and its processes. Item numbers 101 to 126 references the flow diagram.

FIG. 1b Attribute Parameters and Capacities of each

FIG. 1c Example of “Manual” Firewall Code using Code Read Software

FIG. 1d Example Of Invoice Information In Firewall Code Read Format

FIG. 1e Example Of XML Type Invoice Formatting Un Code Read Software

FIG. 1f Example Of “Automated” Encrypted Code Read Firewall Code

FIG. 1g Example of Code Read Consumer Bill Payment

FIG. 1h Code Read Software As A Middleware For Email Productivity Applications

FIG. 2 Screen Modes

This figure shows on overview of some of the program features. Following the flow charts,

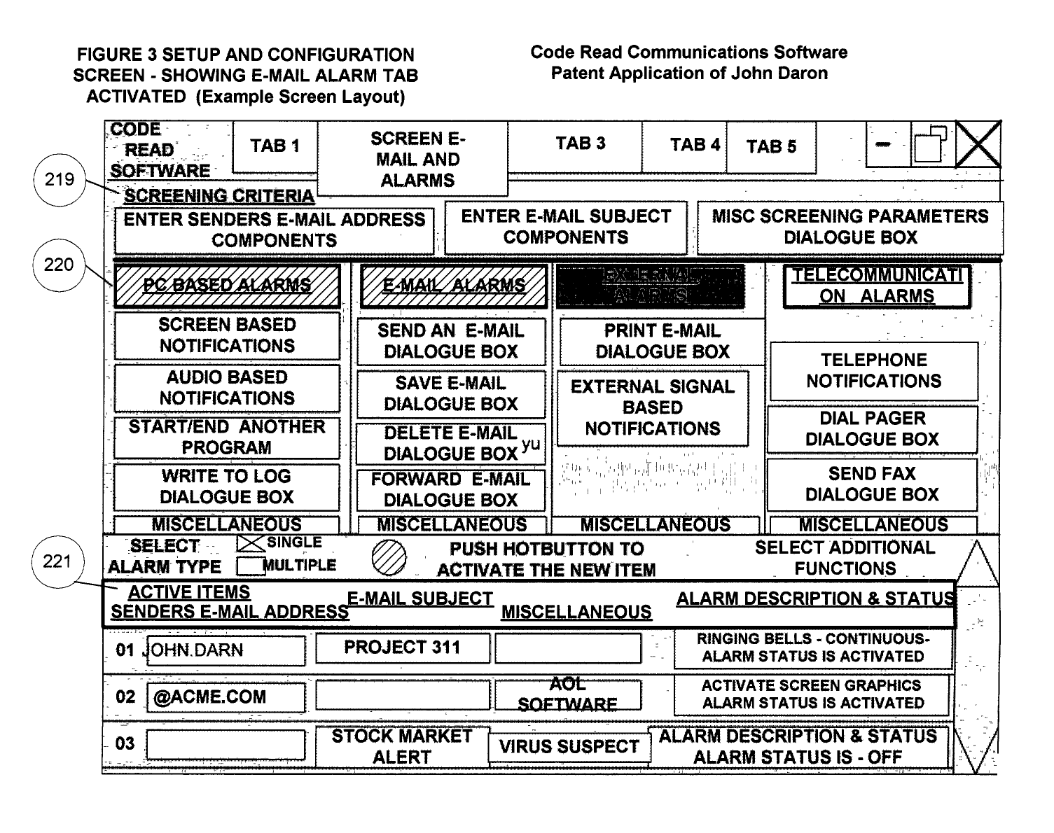

FIG. 3 Setup and Configuration Screen Showing E-mail alarm tab activated

This figure shows potential screen layouts with typical GUI screen arrangements.

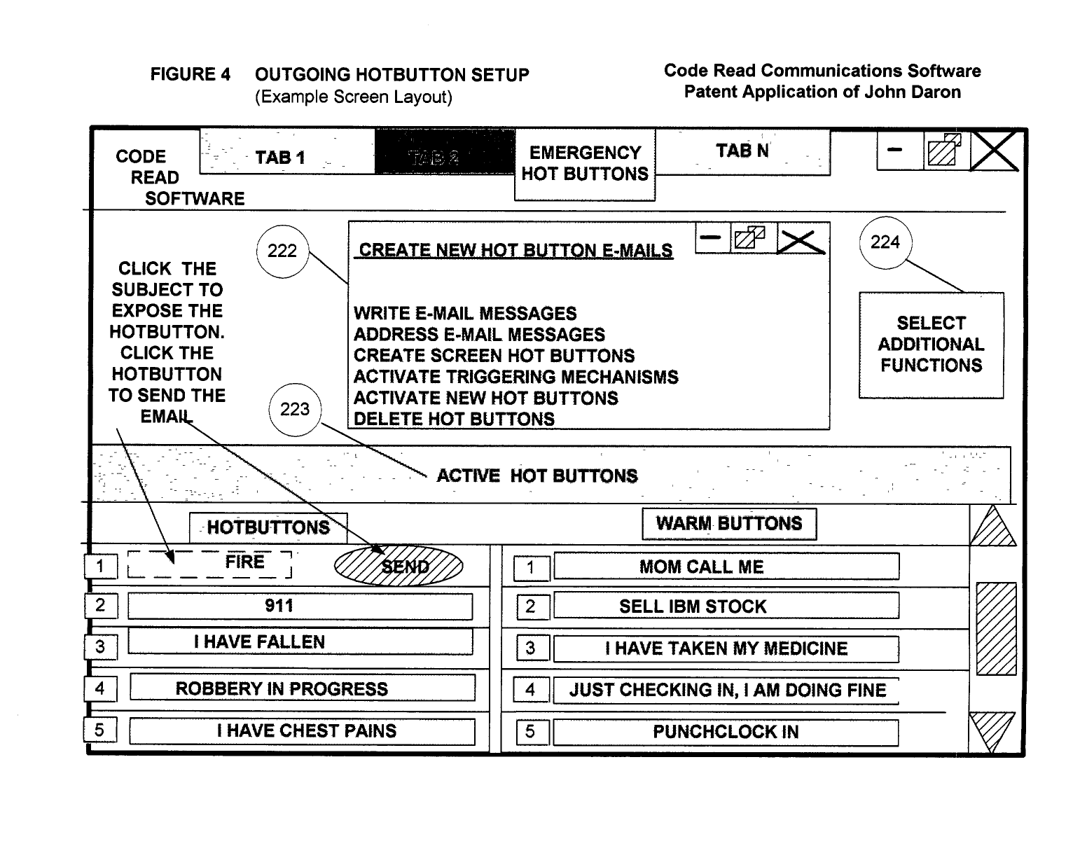

FIG. 4 Outgoing Hotbutton Setup

This figure shows potential screen layouts with typical GUI screen arrangements.

FIG. 5 Bill Payment Mode

This figure shows potential screen layouts with typical GUI screen arrangements.

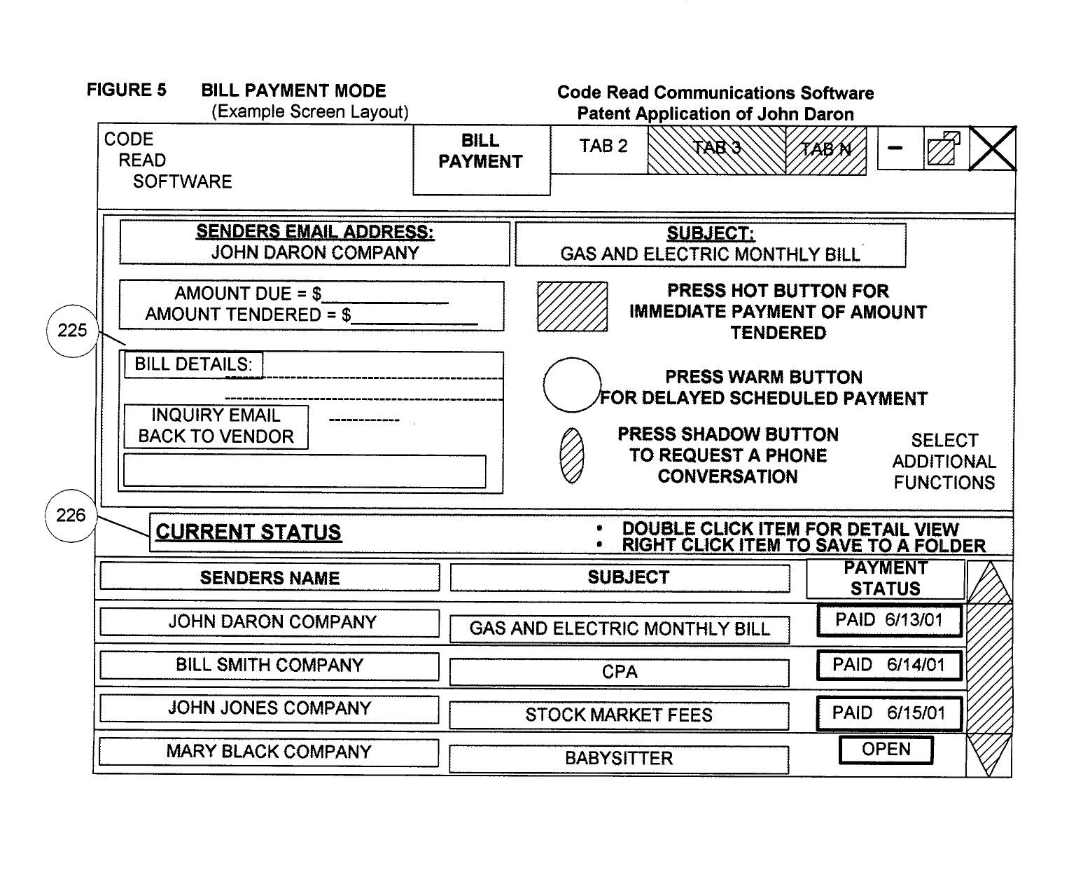

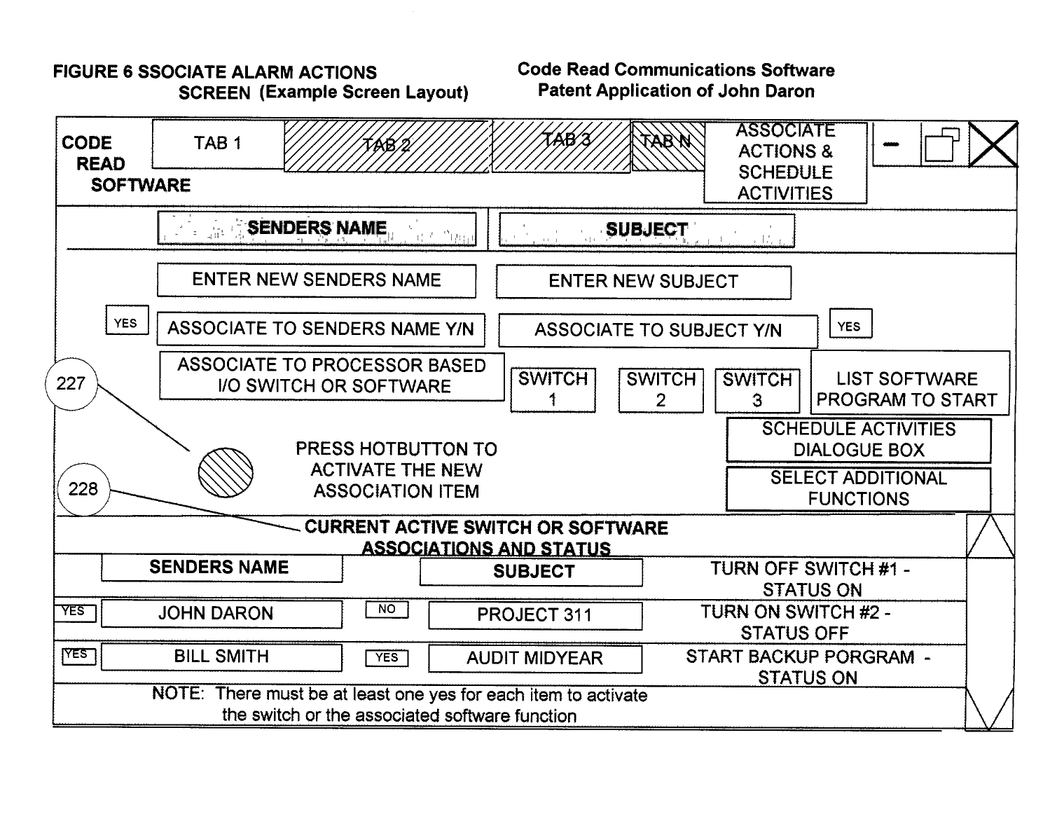

FIG. 6 Associate Alarms actions screen

This figure shows potential screen layouts with typical GUI screen arrangements.

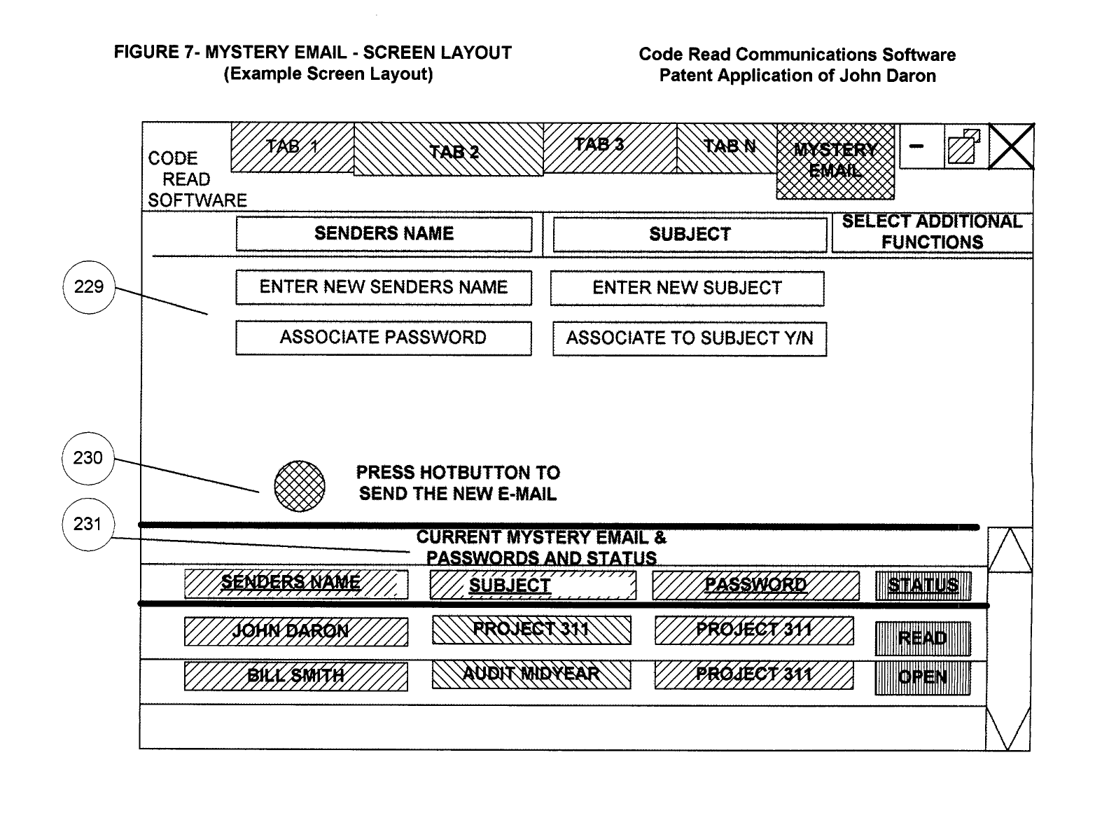

FIG. 7 Mystery Email—Screen Layout

This figure shows potential screen layouts with typical GUI screen arrangements.

Detailed Description of each drawing and its items is as follows:

FIG. 1a Program Flow Diagram Details

The purpose of FIG. 1a is to indicate the scope and flow of the Code Read software program and its patentable processes. Items 101 through 104 are setup and infrastructure items for the software program. Item 105 is an integral part of the program and the business logic which is based on the e-mail characteristics and email formatting information necessary for this software to function.

Items 106 through 126 indicate user portion of the program. Item 106 is a decision point between a user choosing incoming email or outgoing email. Items 107 through 116 are incoming email functions and items 117 through 126 are outgoing email functions.

The individual items in FIG. 1a are as follows:

101 Automated Installation Process

102 Start And Run Program

103 Configure Program And Screening Parameters By Local Or Remote Means Including E-Mail, Network And Web Access

104 Display Of Current Status For All Program Items And A Log Of Program Events

105 A Programming Language And Code Format Specifically Designed For The Communication Of Instructions Between Intelligent Devices Capable Of Receiving E-Mail Messages. (E-Mail Characteristics, Parameters And Messages Contain The Language Codes.)

106 Decision To Operate On Either Incoming E-Mail Or To Operate On Outgoing E-Mail

107 Incoming E-Mail Selection

108 Read Mystery E-Mail

109 Scheduler For Log On

110 Incoming Screening Selection

111 Incoming Email Alarms And Notifications Initiated

112 Incoming Email Automated Responses Initiated (External Devices)

113 Incoming email screening for Invoices For The Bill Payment System

114 Configure Personal Computer Peripheral Devices As Alarm Mechanisms Or As Communications Devices:

Audio Alarms

Visual Alarms

Route E-Mails

Save E-Mail

Erase E-Mail

Dial Designated Phone Numbers

Send Faxes

Dial Pagers

Delete Selected E-Mails

Write To Logs

Shut Down Pc

Create A File Or Folder

Sort E-Mails & Attachments To Folders & Files

Miscellaneous

Send A Network Based Signal

115 Pci Slot I/O Board Or Equivalent Intelligent Switch Or Communication Path

116 External Devices As Alarms Which Are Triggered By Screened E-Mail:

Turn On Or Off An Electrical Circuit

Turn On Or Off An Optical Circuit

Adjust An Output Signal

Print E-Mail

Implement A Telecom Based Signal

Miscellaneous

117 Present E-Mail Bills Or Invoices For Review, Payment Or Comment

118 Outgoing E-Mail Selection

119 Send Mystery E-Mail Selection

120 Hotbutton E-Mail Messages Selection

121 Bill Payment And Scheduler Selection

122 Input: Password Requirements, Senders Name Block Commands, Alarm Commands, Miscellaneous Commands.

123 Activation Methods Including For The Handicapped And By External Sensors

124 Pci Slot I/O Board Inputs

(Sensor Inputs Which Are Transmitted To A Computer Via Input/Output Devices)

125 Operator Inputs for Bill Payment and or Hotbutton Email messages

126 Export Payment Data To Money Or Checkbook Or Accounting Software

The individual items in FIG. 1b are as follows:

200 “From” email attribute parameter. In an email message, the “From” item usually contains the email address of the sender of the email message.

201 “To” email attribute parameter. In an email message, the “To” item usually contains the intended recipient of the email message.

202 “CC” email attribute parameter. In an email message, the “CC” item usually contains the email address information of individuals who are to be copied with the email message.

203 “BCC” email attribute parameter. In an email message, the “BCC” item usually contains the email address information of individuals who are to be copied with the email message, but the copy is to be blind. Blind copy refers to the fact that the intended recipient is blind to the fact that another copy was sent to the “BCC” email address.

204 “SUBJECT” email attribute parameter. In an e-mail message, the “SUBJECT” item usually contains the e-mail title information. It is useful to assist the recipient and others with organizing and recognizing the intended purpose of the email.

205 “ATTACHMENT” email attribute parameter. In an e-mail message, the “ATTACHMENT” item usually contains the file names of files, which are attached to an email message. It is useful to assist the recipient and others with organizing and recognizing the files, which accompany an e-mail message.

The individual items in FIG. 1c are as follows:

204 “SUBJECT” email attribute parameter.

205 “ATTACHMENT” email attribute parameter.

206 “**FWC10000** Hello from Texas” is an example of an email subject serving as an Code Read data or instruction format.

207 “ABCD.doc” is an example of an email attachment file name.

The individual items in FIG. 1d are as follows:

204 “SUBJECT” email attribute parameter.

205 “ATTACHMENT” email attribute parameter.

208 “****COMPANY NAME+++UNIQUE IDENTIFIER NUMBER++++INVOICE DOCUMENT++++INVOICE NUMBER++++DATE DUE++++AMOUNT DUE++++EXISTING BALANCE++++DATE OF LAST PAYMENT++++DISCOUNT AVAILABLE FOR EARLY PAYMENT BY XXXXX DATE++++****” is an example of an email subject shown as an example of invoice data information contained in Code Read format.

209 “ABC Document.doc” ” is an example of an e-mail attachment file name.

The individual items in FIG. 1e are as follows:

204 “SUBJECT” email attribute parameter.

210 “**** <COMPANY NAME> 100 +++ <UNIQUE IDENTIFIER NUMBER> 200 ++++<INVOICE DOCUMENT> 300 ++++<INVOICE NUMBER >400 ++++ <DATE DUE> 500 ++++<AMOUNT DUE> 600++++<EXISTING BALANCE> 700++++<DATE OF LAST PAYMENT> 800++++<DISCOUNT AVAILABLE FOR EARLY PAYMENT BY> 900 XXXXX <DATE> 1000++++****” is an example of an email subject with XML type invoice formatting.

The individual items in FIG. 1f are as follows:

204 “SUBJECT” email attribute parameter.

211 “1245890093903+++−−−−−−−−!!)0jm5901110022929292393903+++−−−−−−−−!!)0jm597987981298101920933837637838398989898889 9998888kakakkddjdhdggdbcmc9c786ghedbenckc949+++−−−−−−−−!!)0jm5998743hdf94” is an example of an e-mail subject which is encrypted and contains data, instructions or both.

The individual items in FIG. 1 g are as follows:

212 Customer selects invoices for payment.

213 Customer authorizes payment by pushing this button.

The individual items in FIG. 1h are as follows:

214 Email Productivity applications

215 Code Read Software

216 Generic Email System

217 Generic Disk Operating System

218 Generic Personal Computer Or Email Hardware Device

### DETAILED DESCRIPTION OF THE INVENTION

Code Read Communication Software—Structure

This software program and language depends on and includes the process of the formatting and or the screening of e-mail message attribute parameters including but not limited to: From, To, CC, BCC, SUBJECT, ATTACHMENTS and, EMAIL MESSAGE, etc as a means to communicate instructions between intelligent devices via e-mail. See Figure (200-205)

The software program and its process of screening e-mail messages parameters for specific formatting, which is the subjects of this patent application, may be structured as a separate “add on” utility software package or it may be integrated as part of another E-mail or browser software such as Internet Explorer, AOL, Netscape Navigator, hotmail, NetZero, Microsoft Outlook, Lotus Notes, or any other commercial product.

Code Read Communication Software Language

This software program and its processes will be coded in a current language such as but not limited to: Visual Basic, C++ or Java and will operate with the popular operating systems including but not limited to: Windows, Unix and Unix derivatives, Apple and IBM and Unisys mainframe operating systems.

This software program and its processes will be structured so as to install in an automated fashion onto a users personal computer or intelligent device.

Code Read Communication Software Features

Some of the features, which this software process will enable, are as follows:

The automatic process of scanning incoming e-mail message attributes for data and instructions and processing the data and instructions based on the user inputs, or programming, which is entered into the Code Read Software application.

See FIG. 1a, Items (103) and (105).

See FIG. 1b (200-205)

See FIG. 1c (206), (207)

See FIG. 1d

Automating the scheduling of an e-mail session via network or telecom or wireless connections to the internet to a allow automatic processes in this same software to scan and process incoming e-mail messages

See FIG. 1a, Items (109)

Associating and activating alarms and notifications based on e-mail parameters and characteristics.

See FIG. 1a, Items (103),(111) and (114).

See FIG. 3

Select screening criteria (219)

Select alarm type (220)

Review alarm states (221)

Providing preformatted and addressed outgoing e-mail for individuals or companies to handle emergency and urgent messages and notifications

See FIG. 1a, Items (120) and (125).

See FIG. 4

Create new hotbutton email (222) and review active hot buttons (223)

Providing a link for triggering mechanisms for the sending of outgoing preformatted and addressed emergency e-mails by:

a) Conventional methods such as keyboard or mouse

b) Unconventional methods such as a handicapped person would

c) By automatic means to sense signals originating from sensors and appliances.

See FIG. 1a, Items (123) (124) and (120).

See FIG. 4 (224)

Screening incoming e-mail and sorting and directing vendor and invoice related incoming e-mails for payment and providing a mechanism for authorizing payments to vendors via e-mail messages

See FIG. 1a, Items (110),(113),(117),(126)and (121)

See FIG. 5

Process incoming invoices (225) and review current status accounts (226)

See FIG. 1b (200-25)

Using incoming e-mail parameters and characteristics to activate other appliances as well as other PC functions, intelligent devices and software programs

See FIG. 1a, Items (112),(115)and (116)

See FIG. 6

Associate alarm actions (227) and review active alarms status (228)

See FIG. 1b (200-205)

Password protecting e-mail and transmitting the password within the e-mail parameters and header information.

See FIG. 1a, Items 108,122,119

See FIG. 7

Create new password protected emails (229). Send password protected emails (230). Enter password information and read incoming mystery emails (231).

Automated Installation of the program

See FIG. 1a, Items (101)

Display of all items and a log of program activity

See FIG. 1a, Items (104)

Provide mechanisms whereby this software program can be configured and activated by a variety of methods including but not limited to local items such as keyboards, mouse, touch screen, touch pad, retina tracking or by remote methods including but not limited to e-mail, web access, network access, telecommunications access, optical communications, satellite communications or wireless communications.

See FIG. 1a, Items (118), 120,123,124,125

See FIG. 4This program will be displayed in various screen modes which are operator controlled

See FIG. 2

Examples of the Use of Code Read Software

Examples of uses of this invention with incoming e-mail are:

1 A specific incoming e-mail that contains a parameter that this program is looking for such as the senders e-mail address is john.doe@main.com. See FIG. 1b (200)

This would signal the personal computer, using this program, to automatically print the incoming e-mail, or forward it to a group of end users working on a project.

See FIG. 1a, Items 17,110,111,114

See FIG. 3 (219) (220) (221)

2) A specific incoming e-mail would signal the personal computer, using this program, to issue a continuous phone ring sound when and only when an e-mail with the word ACME in the senders e-mail subject line is received. See FIG. 1b (200)

See FIG. 1a, Items 17,110,111,114

See FIG. 3

3) a specific incoming e-mail, which was detected by this software program, would signal an electrical contact to be closed and result in an electrical appliance being turned on. This software program would implement this action by sending a software signal to the personal computer i/o card which resides in a pci slot. The i/o card would close contacts to allow the flow of current to be turned on or off based on an incoming e-mail.

See FIG. 1a, Items 117,110,115 and 116

See FIG. 6 (227) (228)

4) A specific incoming e-mail, which was detected by this software program, would screen and identify the e-mail as a bill from a vendor FIG. 1b (200) and sort it into a folder to be processed by the user at bill payment time. The customer or user of this program would only have to reply back to the vendor by reply e-mail FIG. 5 (225) that the invoice is accurate and approval is issued for a transfer of funds by a prearranged payment vehicle such as a credit card number, which is in possession of the vendor.

See FIG. 1a, Items, 110,113,117,121 and 125

See FIG. 1d

See FIG. 1e

See FIG. 1g

See FIG. 5 (225) (226)

Examples of uses of this invention with outgoing e-mail are:

1) A person is having a heart attack. He clicks on the Hot Button on his computer to send and e-mail to a 911 facility regarding a heart attack FIG. 4 (223). Hot Button outgoing e-mails are pre-typed, pre addressed automated e-mails for fast, accurate notification in the event of an emergency or urgent action request. The transmission of these outgoing e-mails may be initiated by many means including a mouse click. The advantage to the user is he

doesn't have to call 911 and then give his information, then call the doctor to come to the hospital, then call his wife to tell her where he is going, then call a neighbor who could offer CPR until the ambulance arrives. The 4 calls in this example would be replaced with one click of the mouse. The receiving computers, when set up with this software would receive a loud verbal alarm when this message appeared at their computer. This software could also initiate multiple phone calls w synthesized voice messages as well as faxes and pager alerts.

See FIG. 1a, Items 118,120,123,125

See FIG. 4, (222), (223), (224)

2) A burglar alarm signals a personal computer via an i/o card in a pci slot in the computer. An e-mail containing all the homeowner information would be issued to the proper authorities to respond to the alarm.

See FIG. 1a, Items 118,120,123,124,125

See FIG. 6 (227), (228)

3) An inventory of items like medicine, which were scanned as they were used, would signal the computer input/output card in a PCI slot in a personal computer. The e-mail response would signal a reorder of the medicine in this example.

See FIG. 1a, Items 118,120,123,124,125

See FIG. 6 (227), (228)

4) A user wants to send and e-mail with a password requirement. He opens the mystery mail feature in this software and enters the password. The recipient must have the password to open and read the message or attachment.

See FIG. 1a, Items 122,119,118

See FIG. 7 (229), (230), (231)

I claim:

1. The Process of E-mail communicating instructions and or data between intelligent devices capable of sending and receiving e-mail messages comprising:
(a) The formatting of e-mail message parameters to provide the ability to sort and further process incoming e-mail messages and to communicate instructions and or data to an intelligent device(s) via the e-mail transaction including, but not limited to, one or more of the following parameters: e-mail author (From), e-mail recipient (To), subject of e-mail message (Subject feature), copied entities (CC feature), blind copied entities (Bcc feature), e-mail message file characteristics, e-mail message content, attachment file names and attachment content.
(b) The screening of e-mail message parameters to provide the ability to sort and further process incoming e-mail messages and to communicate instructions and or data to an intelligent device(s) via the e-mail transaction including, but not limited to, one or more of the following parameters: e-mail author (From), e-mail recipient (To), subject of e-mail message (Subject feature), copied entities (CC feature), blind copied entities (Bcc feature), e-mail message file characteristics, e-mail message content, attachment file names and attachment content.
(c) The Automatic and or manual Screening and or formatting of e-mail messages parameters for the purpose of communicating instructions and or data with e-mail and or e-mail transactions.
(d) The formatting and or screening of email message parameters manually or automatically, to convey and communicate instructions and or data to remote systems or intelligent devices, which receive the e-mail messages or which subsequently communicate with the e-mail receiving device.
(e) The use of a combination of e-mail parameters and message content within an e-mail message or within a combination of e-mail messages, which together act as a programming language or as a means to communicate instructions and or data from one intelligent device to another.

2. The process of claim 1, wherein the said “further process incoming e-mail messages” means the use of this process to communicate data and or instructions to Computer System Peripheral Devices or to Intelligent Device Peripherals.

3. The process of claim 1, wherein the said formatting of e-mail message parameters means the formatting of outgoing e-mail which includes e-mail going to any second intelligent device or any e-mail address whether it is in another location or simply in another location within the same intelligent device.

4. The process of claim 1 wherein said ability to sort and further process incoming e-mail messages and to communicate data and instructions to an intelligent device(s) via the e-mail transaction means the process of Automated Bill Payment by the screening and sorting of incoming e-mail messages for invoices and bills and the subsequent sending of e-mail authorizations to the vendors who already possess the secure payment means and or information of a customer.

5. The process of claim 1 wherein said communicating instructions and or data means the means to control external devices, which are connected in some fashion to a computer or intelligent device capable of receiving e-mail messages

6. The process of claim 1 wherein said communicating instructions and or data means the ability to send and receive password protect e-mail messages with the password information residing in the e-mail parameter formatting as data and or instructions.

7. The process of claim 1 wherein said programming language means a software Architecture consisting of the structuring and formatting of one or more e-mails and their parameters as a code which will communicate instructions and or data to a remote computer or intelligent device which is capable of receiving e-mail messages.

8. The process of claim 1 wherein said sort and further process incoming e-mail messages means the ability to create an e-mail workflow process.

9. The process of claim 1 wherein said user is provided with a detailed display, status and log of past and current alarm conditions.

10. The process of claim 1 wherein said user is provided with means to Operate, configure and Setup this program and its parameters and variables by local and by remote means.

11. The process of claim 1 wherein said user is provided with means for an assortment of screen modes, which are options for the operator.

12. The process of claim 1 wherein said user is provided with means for an assortment of screen modes, which are options for the operator.

13. A software Process of Automating the creation and storage of e-mail messages which will be sent at a later time comprising:
(a) The means to create and store complete e-mail messages, which can be sent manually, or which can be sent in an automated fashion.
(b) The means to associate conditions to trigger and send a stored e-mail message
(c) The means to provide and implement manual inputs to trigger and send a stored e-mail message
(d) The means to provide automated inputs to trigger and send a stored e-mail message
(e) The means to trigger the subsequent transmittal of the e-mail messages.

14. The process of claim 13 wherein, said creation and storage of e-mail message means formatting in the e-mail parameters or a combination of the e-mail parameters and the e-mail message for the purpose of transmitting data and or instruction to another device.

15. The process of claim 13 wherein said Means to associate conditions to trigger and send a stored e-mail message means that stored e-mail messages are sent in response to sensors or other inputs means.

16. The process of claim 13 wherein said storage of e-mail messages means e-mail messages with instructions and or data formatted into the e-mail parameters and the e-mail message and or computer software code, which is formatted in the e-mail parameters and the e-mail message.

17. The process of claim 13 wherein said user is provided with a detailed display, status and log of past and current trigger conditions.

18. The process of claim 13 wherein said user is provided with the Operation, configuration and Setup capabilities for this program and its parameters and variables by local and by remote means.

19. The process of claim 13 wherein said user is provided with an assortment of screen modes, which are options for the operator.

20. The process of claim 13 wherein said user is provided with an assortment of screen modes, which are options for the operator.
